(19) United States
(12) Patent Application Publication
(10) Pub. No.: US 2010/0228825 A1
(43) Pub. Date: Sep. 9, 2010

(54) SMART MEETING ROOM

(75) Inventors: Rajesh Kutpadi Hegde, Redmond, WA (US); Xuedong David Huang, Bellevue, WA (US); Sharon Kay Cunnington, Sammamish, WA (US); Jin Li, Sammamish, WA (US); Michel Pahud, Redmond, WA (US); Ryan M. Burkhardt, Redmond, WA (US); Kori Marie Quinn, Redmond, WA (US); Jayman Dalal, Kirkland, WA (US); Zhengyou Zhang, Bellevue, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/399,518

(22) Filed: Mar. 6, 2009

(51) Int. Cl. G06F 15/16; G06F 3/00; G06F 21/00

(52) U.S. Cl. 709/204; 715/753; 726/3; 709/227

(57) ABSTRACT

The claimed subject matter provides a system and/or a method that facilitates enhancing the employment of a telepresence session. An automatic telepresence engine that can evaluate data associated with at least one of an attendee, a schedule for an attendee, or a portion of an electronic communication for an attendee. The automatic telepresence engine can identify at least one the following for a telepresence session based upon the evaluated data: a participant to include for the telepresence session, a portion of data related to a presentation within the telepresence session, a portion of data related to a meeting topic within the telepresence session, a device utilized by an attendee to communicate within the telepresence session. The automatic telepresence engine can initiate the telepresence session within a communication framework that includes two or more virtually represented users that communicate therein.

### BACKGROUND

Computing and network technologies have transformed many aspects of everyday life. Computers have become household staples rather than luxuries, educational tools and/or entertainment centers, and provide individuals and corporations with tools to manage and forecast finances, control operations such as heating, cooling, lighting and security, and store records and images in a permanent and reliable medium. Networking technologies like the Internet provide individuals virtually unlimited access to remote systems, information and associated applications.

In light of such advances in computer technology (e.g., devices, systems, memory, wireless connectivity, bandwidth of networks, etc.), mobility for individuals has greatly increased. For example, with the advent of wireless technology, emails and other data can be communicated and received with a wireless communications device such as a cellular phone, smartphone, portable digital assistant (PDA), and the like. As a result, physical presence for particular situations has drastically reduced or been reduced. In an example, a business meeting between two or more individuals can be conducted virtually in which the two or more participants interact with one another remotely. Such virtual meetings that can be conducted with remote participants can be referred to as a telepresence session.

Traditional virtual meetings include teleconferences, web-conferencing, or desktop/computer sharing. Yet, each virtual meeting may not sufficiently replicate or simulate a physical meeting. Moreover, virtual meetings require numerous settings and configurations that must be defined or provided manually. For example, a teleconference requires a notification to the attendees with pass codes, meeting identifications, and the like. To attend the teleconference, the participant must manually input data such as a dial-in number, a meeting identification, a password, a spoken description for participant identification, etc. Furthermore, during such virtual meetings, data sharing is limited and restricted to data previously delivered or local data accessible via desktop/computer sharing.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate automatically initiating and setting up a telepresence session leveraging a smart meeting room. An automatic telepresence engine can generate a smart meeting room or smart room that can seamlessly automate various features of the telepresence session. The smart room can employ various automatic settings for a telepresence session in which local and remote users can participate. The room or telepresence session can automatically identify the participants, information about the participants, documents needed for the meeting, etc. The smart room can further identify the right mode of communication to use for the documents (e.g., upload, hard copy, email address, server upload, website delivery, etc.). In general, the smart room can take care of all the telepresence session needs revolving around the users, data, documents, and the like. In another aspect, the room can provide archiving, event summaries, rosters, follow ups, and even access to related meetings.

As one example, the smart meeting room can detect people with a face scan to identify participants, user preferences, and documents that are useful for collaboration. The data can be automatically uploaded to an accessible file share in real time. The room can provide emails that include summaries of meetings to participants. For example, in a second meeting related to a first meeting, one can access the archive to allow for accurate referencing of the first meeting. In addition, the smart room can provide the use of a previous meeting to identify deadlines, facts, meeting minutes, etc. In other aspects of the claimed subject matter, methods are provided that facilitate automatically initiating a telepresence session for participants and related data.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates automatically initiating a telepresence session for participants and related data.

FIG. 2 illustrates a block diagram of an exemplary system that facilitates seamlessly collecting data corresponding to a telepresence session, attendees, or presented material.

FIG. 3 illustrates a block diagram of an exemplary system that facilitates employing a telepresence session in accordance with participant telepresence profiles.

FIG. 4 illustrates a block diagram of an exemplary system that facilitates interacting with a participant within a telepresence session while excluding other participants from such communications.

FIG. 5 illustrates a block diagram of exemplary system that facilitates enabling two or more virtually represented users to communicate within a telepresence session on a communication framework.

FIG. 6 illustrates a block diagram of an exemplary system that facilitates automatically conducting a telepresence session for two or more virtually represented users.

FIG. 7 illustrates an exemplary methodology for automatically initiating a telepresence session for participants and related data.

FIG. 8 illustrates an exemplary methodology that facilitates seamlessly collecting data corresponding to a telepresence session, attendees, or presented material.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “data store,” “session,” “engine,” “organizer,” “collector,” “device,” “module,” “manager,” “application,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

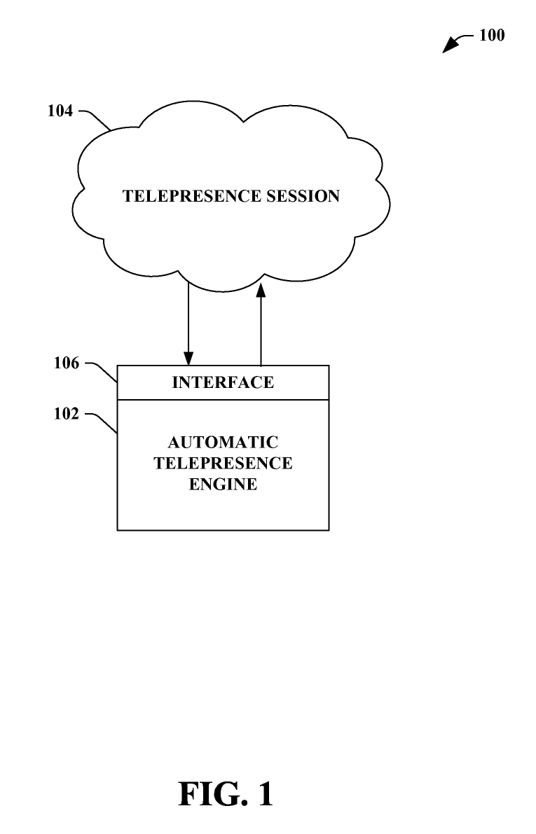

Now turning to the figures, FIG. 1 illustrates a system 100 that facilitates automatically initiating a telepresence session for participants and related data. The system 100 can include an automatic telepresence engine 102 that can automatically initiate a telepresence session 104 based upon collected and evaluated data. In general, the automatic telepresence engine 102 can start, conduct, and terminate the telepresence session without manual intervention. The automatic telepresence engine 102 can evaluate data in order to identify attendees (e.g., participants, virtually represented users that are to attend the telepresence session, etc.), data related to a presentation within the telepresence session, data related to a meeting topic within the telepresence session, a need for a telepresence session, and/or devices utilized by attendees to communicate within the telepresence session. It is to be appreciated that an attendee can be an actual, physical participant for the telepresence session, a virtually represented user within the telepresence session, two or more physical people within the same meeting room, and the like. Moreover, the automatic telepresence engine 102 can provide automated data archiving/capturing during the telepresence session that can track telepresence session minutes. With the telepresence session 104 being automatically tracked or recorded, a termination of such session can trigger the automatic telepresence session 102 to create and/or transmit a summary including events, topics, attendees, material discussed, etc.

By leveraging the automatic telepresence engine 102, various settings and configurations can be performed and implemented without user intervention or manual configuration. For example, typical virtual meetings require manual input or intervention such as selecting meeting attendees, data required for the meeting, initiating meeting recordation (e.g., recording audio, recording video, etc.), activating data sharing (e.g., desktop/computer sharing, data files, etc.). However, the automatic telepresence engine 102 can automatically identify data, attendees, and recordation data in order to eliminate manual intervention or input. In other words, the automatic telepresence engine 102 can evaluate data in order to automatically initiate the telepresence session 104 with attendees (e.g., virtually represented users), data utilized for the session, and/or any other necessary data to conduct the telepresence session 104.

In particular, the automatic telepresence engine 102 can evaluate data associated with at least one of a virtually represented user, a schedule for a virtually represented user, a portion of an electronic communication for a virtually represented user, and/or any other suitable data identified to relate to at least one of the virtually represented user or the telepresence session 104. The automatic telepresence engine 102 can further identify at least one the following for a telepresence session based upon the evaluated data: a participant to include for the telepresence session, a portion of data related to a presentation within the telepresence session, a portion of data related to a meeting topic within the telepresence session, a device utilized by a virtually represented user to communicate within the telepresence session. With such evaluation and identification of data, the telepresence session 104 can be initiated, conducted, and recorded (e.g., tracked, monitored, archived, etc.) without active manual user intervention or input.

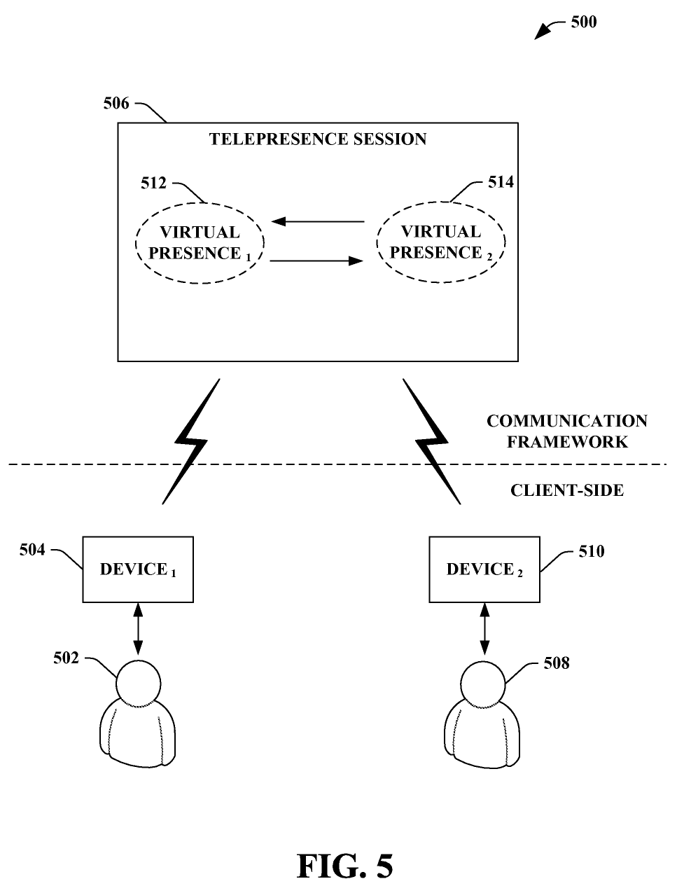

The telepresence session 104 (discussed in more detail in FIG. 5) can be a virtual environment in which two or more virtually represented users can communicate utilizing a communication framework. In general, a physical user can be represented within the telepresence session 104 in order to communicate to another user, entity (e.g., user, machine, computer, business, group of users, network, server, enterprise, device, etc.), and the like. For instance, the telepresence session 104 can enable two or more virtually represented users to communicate audio, video, graphics, images, data, files, documents, text, etc. It is to be appreciated that the subject innovation can be implemented for a meeting/session in which the participants are physically located within the same location, room, or meeting place (e.g., automatic initiation, automatic creation of summary, etc.).

In addition, the system 100 can include any suitable and/or necessary interface component 106 (herein referred to as “the interface 106”), which provides various adapters, connectors, channels, communication paths, etc. to integrate the automatic telepresence engine 102 into virtually any operating and/or database system(s) and/or with one another. In addition, the interface 106 can provide various adapters, connectors, channels, communication paths, etc., that provide for interaction with the automatic telepresence engine 102, the telepresence session 104, and any other device and/or component associated with the system 100.

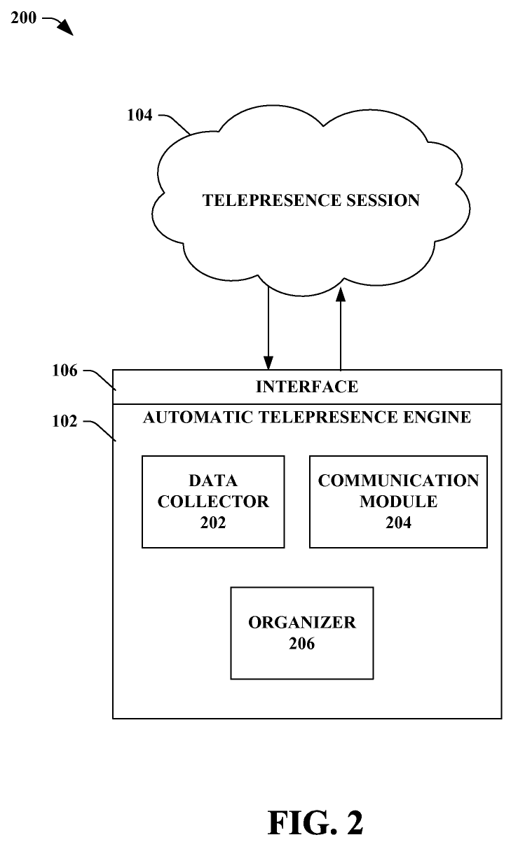

FIG. 2 illustrates a system 200 that facilitates seamlessly collecting data corresponding to a telepresence session, attendees, or presented material. The system 200 can include the automatic telepresence engine 102 that can evaluate data in order to initiate and conduct the telepresence session 104 with identified attendees, data, and the like. Generally, the automatic telepresence engine 102 can evaluate data to identify core aspects utilized for the telepresence session 104, wherein such core aspects can relate to who is attending the telepresence session 104 (e.g., presenters, virtually represented users, attendees, audience, etc.), what is being presented within the telepresence session 104 (e.g., presentation materials, documents, pictures, video, data files, word processing documents, slide presentations, computer programmable code, audio clips, camera feeds, etc.), how data is being presented within the telepresence session for each participant (e.g., available devices, input devices, output devices, etc.), capturing data presented within the telepresence session 104 (e.g., tracking, recording, monitoring, archiving, etc.), and creating a summary of the telepresence session 104.

The system 200 can include a data collector 202 that can gather data in real time in order to automatically generate the telepresence session 104. The data collector 202 can evaluate any suitable data utilized with the telepresence session 104. For example, the data collector 202 can evaluate data associated with at least one of a virtually represented user (e.g., personal information, employment information, profile data, biographical information, etc.), a schedule for a virtually represented user (e.g., calendar, online calendar, physical calendar, scheduling data on a device, electronic mail application, etc.), or a portion of an electronic communication for a virtually represented user (e.g., phone calls, emails, online communications, text messages, short message service (SMS) messages, chat program communications, physical mail, pages, messaging applications, voicemails, etc.). Based at least in part upon such evaluation of data, the data collector 202 can identify information that can be utilized with the telepresence session 104. For example, based upon evaluating an email application and included emails, the data collector 202 can identify a need for a telepresence session between two users and that the two users can meet at a particular time (e.g., availability based upon evaluating calendar/schedule data) to discuss specific data or documents (e.g., data or documents can be identified and made accessible for the telepresence session). For example, the user can be identified utilizing face recognition, voice recognition, a biometric reading, etc. Even though the meeting schedule has a list of attendees, not all of them show up for the meeting. Moreover, the meeting can be updated to include an invitee not included on the original list of attendees (e.g., a last-minute participant addition, etc.). So, this type of recognition can help to ascertain who's actually in the meeting and also such information can be used to display a name tag or identification for that person in their virtual representation so others tuned into the telepresence session can get information without interrupting.

In other words, the data collector 202 can gather data such as who is attending the telepresence session, what is to be discussed or presented (e.g., data, documents, etc.), when the telepresence session can take place (e.g., evaluating schedules/calendars to identify potential or dates to have the session), and the like. For instance, the data collector 202 can ascertain whether or not a telepresence session is to be initiated or scheduled between particular individuals in order to discuss particular topics, data, documents, etc. Such determination can be identified based at least in part upon evaluating communications, interactions, assignments (e.g., projects, workload, etc.), scheduling data, calendar data (e.g., deadlines, timelines for action items, etc.), and the like. Thus, based upon a project action item deadline in which such aspects that need to be handled are by a group of users, the data collector 202 can identify such need for a scheduled telepresence session with the appropriate attendees (e.g., the group of users, managers, advisors, etc.) with the necessary data.

In another example, the data collector 202 can identify if the user is in the meeting room or remote. If remote, there is a need for the initiation of the telepresence session. If all users are local, then there may be a need for a telepresence session depending on the needs of such a meeting. For instance, even if all users are local, users need to show some presentation on a large screen display, or a need to record the summary of the meeting. It is to be appreciated that some of the components of the subject innovation can be exist outside of a telepresence (e.g., a meeting recorder, summarizer, organizer, etc.).

The automatic telepresence session can further include a communication module 204 that can evaluate invited or potential attendees for the telepresence session 104 in order to ascertain available devices for communication within the telepresence session 104. In other words, the communication module 204 can manage devices for each virtually represented user in order to optimize the features of such devices within the telepresence session 104. The devices can be, but are not limited to, a laptop, a smartphone, a desktop, a microphone, a live video feed, a web camera, a mobile device, a cellular device, a wireless device, a gaming device, a portable digital assistant (PDA), a headset, an audio device, a telephone, a tablet, a messaging device, a monitor, etc.

For example, a first user may have access to a laptop with an email account, a cellular device, a webcam, and a wireless headset. Based on such identification of the available devices, the communication module 204 can enable interaction with the telepresence session 104 utilizing such devices. Moreover, the communication module 204 can leverage such available devices in order to optimize delivery or communication of data to such user. For instance, by ascertaining the available devices for a user, data can be optimally communicated to such user. Such criteria for identifying the optimal mode of data delivery can be, but is not limited to, bandwidth, device features (e.g., screen size, performance, processor, memory, peripherals, resolution, Internet access, security, input capabilities, output capabilities, etc.), geographic location, service plans (e.g., cost, security, peak-hours, etc.), user-preference, data to be delivered (e.g., size, sensitivity, urgency, etc.), and the like. Additionally, the input or output capabilities for each device can be optimally selected or adjusted. For example, audio input (e.g., microphones) on various devices can be adjusted or utilized as well as audio output (e.g., speakers) on various devices.

The communication module 204 can further seamlessly bridge remote and local users virtually represented within the telepresence session 104. In particular, a telepresence session can include participants on a first network as well as participants on a second network, wherein such interaction between various networks can be managed in order to allow data access, data sharing, security, authentication, and the like. The communication module 204 can enable authentication between various participants on disparate networks and provide secure data communications therewith independent of the network.

The system 200 can further include an organizer 206 that can track, monitor, and/or record the telepresence session 104 and included communications. The organizer 206 can manage recordation of data such as, but not limited to, communications (e.g., audio, video, graphics, data presented, data accessed, data reviewed, transcriptions, portions of text, etc.), attendees, participation (e.g., which user communicated which data, etc.), notes taken by individual participants, a stroke to a whiteboard, an input to a whiteboard, an input to a chalkboard, an input to a touch screen, an input to a tablet display, and the like. In general, the organizer 206 can handle archiving, tracking, and storing any suitable data related to the telepresence session 104. It is to be appreciated that the organizer 206 can provide metadata, tags, and/or any other suitable archiving techniques. Such tags or labeling of data can be based upon events, wherein the events can be, but are not limited to, topics presented, data presented, who is presenting, what is being presented, time lapse, date, movement within the telepresence session, changing between devices for interaction within the telepresence session, arrival within the session of virtually represented users, departure from the session from virtually represented users, etc. Moreover, the organizer 206 can enable sharing and/or linking the recorded data. For instance, the recorded data for a first telepresence session can be linked to a second meeting based upon an automatic determination or a request (e.g., user request, etc.). The link can be based upon a related topic, related attendees, etc. in which a portion of the first telepresence session can correspond to the second telepresence session. Additionally, a portion of the recorded data or stored data can be shared with any other suitable entity (e.g., a group, an enterprise, a web site, the Internet, a server, a network, a telepresence session, a machine, a device, a computer, a virtually represented user within a telepresence session, or a portable device, etc.) or user. Furthermore, it is to be appreciated that the organizer 206 can enable such stored or recorded data to be searched with a query. For example, a search on a telepresence session can include a query such as “presenter =name and words said,” or “topic=[insert topic to query] and presenter=name and meeting date=[insert meeting date to query].”

The organizer 206 can further generate a summarization or a “highlight” of the telepresence session 104 that can include any suitable portion of the recorded data or stored data. In other words, the organizer 206 can allow a participant to be informed in a scenario of the participant stepping out (e.g., leaving the meeting or session, etc.), being tardy (e.g., late to the session or meeting, etc.). For example, the organizer 206 can be configured to automatically deliver (e.g., email, stored locally, stored remotely, stored on a local drive/network, stored on a remote drive/network, etc.) such summary to identified users (e.g., identified automatically such as attendees, identified by designation, etc.). The summary can be, for instance, a transcription, an outline, an audio file, a video file, a word processing document, a meeting minutes document, a portion of data with participant identified data (e.g., user-tagging, etc.), pictures, photos, presented material, etc. Moreover, it is to be appreciated that the summarization of the telepresence 104 can be created in real time during the telepresence session and distributed to designated entities. In addition, the system 200 can provide a quick way for late corners to the meeting to come to speed without interrupting others. Summarization and quick playback of salient events on that user's device can help them quickly understand what's went on before they joined the meeting.

For example, the organizer 206 can handle a scenario where a participant has to step out of the telepresence session (e.g., the smart meeting room, etc.) for a time period during the telepresence session. For instance, the participant can see a high level very crisp summary update appearing on his/her device (e.g., PDA, mobile device, device utilized to communicate with the telepresence session, etc.) as the telepresence session continues with a picture/video/etc. of the current speaker. The participant may temporarily leave or not be in range/contact with a device to communicate with the telepresence session. In particular, the user can utilize an alarm (e.g., on participant speaking alarm, etc.) that can inform him/her when a specific participant is talking. Similarly, the participant temporarily out of contact or communication with the telepresence session can set an on subject changing alarm that can inform him/her when the subject is changing. It is to be appreciated that any suitable alarm or event can be utilized to trigger the designated notification for the participant that is out of communication with the telepresence session.

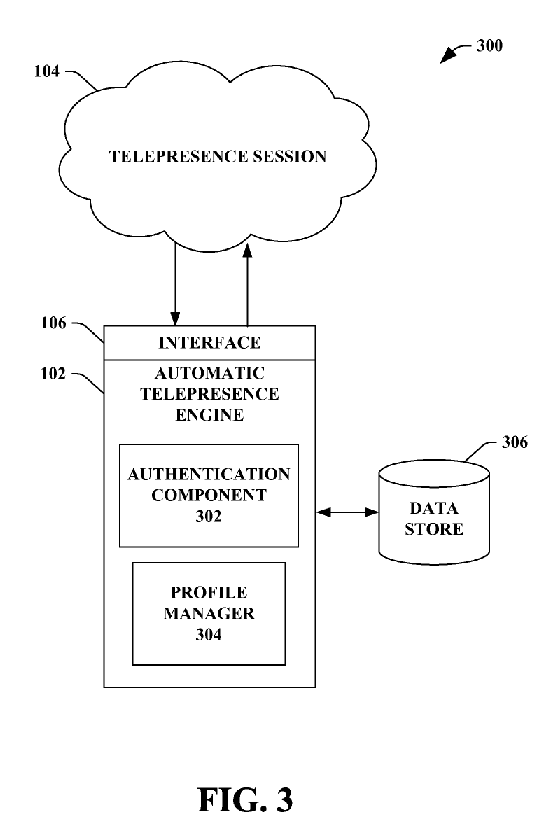

In another instance, when a participant steps out of the automatically initiated telepresence session and comes back, he/she can be automatically updated with pertinent information to quickly catch-up with the current state of the meeting/session. For example, the telepresence session can detect topics and changes in such topics during the telepresence session (e.g., using the meeting agenda content, context change in the discussion, etc). When a participant step out of the session during “Topic 1” and come back during “Topic 2”, the telepresence session can suggest to give directly a quick summary on where the meeting is on “Topic 2” so far so the participant can efficiently jump back into the current discussion, and get an update on “Topic 1” later on. In yet another instance, the degree of summarization can vary within the same topic. For example, if the participant comes back in the room after “Topic 2” has been discussed for a while, he/she would get a very crisp summary of the beginning of “Topic 2” with outcomes, a less summarized middle part, and the last 3 sentences in full. Moreover, the above concepts can be applied for participants that join the telepresence session after the start time of the session. FIG. 3 illustrates a system 300 that facilitates employing a telepresence session in accordance with participant telepresence profiles. The system 300 can enhance the automatically initiated and conducted telepresence session 104. The automatic telepresence engine 102 can evaluate and ascertain attendees, telepresence session relevant data, and devices for virtually represented users for interaction within the telepresence session 104. Moreover, the automatic telepresence engine 102 can include an authentication component 302 and/or a profile manager 304.

The authentication component 302 can provide security and authentication for at least one of a virtually represented participant (e.g., a participant communicating with the telepresence session 104 that maps to a real, actual person or entity), data access, network access, server access, connectivity with the telepresence session 104, or data files. The authentication component 302 can verify participants within the telepresence session 104. For example, human interactive proofs (HIPS), voice recognition, face recognition, personal security questions, and the like can be utilized to verify the identity of a virtually represented user within the telepresence session 104. Moreover, the authentication component 302 can ensure virtually represented users within the telepresence session 104 have permission to access data automatically identified for the telepresence session 104. For instance, a document can be automatically identified as relevant for a telepresence session yet particular attendees may not be cleared or approved for viewing such document (e.g., non-disclosure agreement, employment level, clearance level, security settings from author of the document, etc.). It is to be appreciated that the authentication component 302 can notify virtually represented users within the telepresence session 104 of such security issues or data access permissions.

The profile manager 304 can employ a telepresence profile for a virtually represented user that participants within the telepresence session 104. The telepresence profile can include settings, configurations, preferences, and/or any other suitable data related to a user in order to participate within the telepresence session 104. For example, the telepresence profile can include biographical information (e.g., age, location, employment details, education details, project information, assignment specifications, contact information, etc.), geographic location, devices used for telepresence (e.g., inputs preferred, outputs preferred, data delivery preferences, etc.), authentication information, security details, privacy settings, archiving preferences (e.g., stored location, delivery preferences, medium/format, etc.), information related to initiating/conducting telepresence sessions based on preferences (e.g., scheduling data, historic data related to past attendees for sessions, historic data related to past sessions, etc.), and the like. Additionally, the profile manager 304 can enable a telepresence profile to be created, deleted, and/or edited. For example, a new user to telepresence sessions can create a telepresence session based on his or her preferences, whereas a user with a previously created telepresence profile can update or edit particular details of such profile. Furthermore, a user can delete his or her telepresence profile.

The system 300 can further include a data store 306 that can include any suitable data related to the automatic telepresence engine 102, the telepresence session 104, the authentication component 302, the profile manager 304, the data collector (not shown), the communication module (not shown), the organizer (not shown), etc. For example, the data store 306 can include, but not limited to including, data associated with at least one of a virtually represented user (e.g., personal information, employment information, profile data, biographical information, etc.), a schedule for a virtually represented user (e.g., calendar, online calendar, physical calendar, scheduling data on a device, electronic mail application, etc.), or a portion of an electronic communication for a virtually represented user (e.g., phone calls, emails, online communications, text messages, short message service (SMS) messages, chat program communications, physical mail, pages, messaging applications, voicemails, etc.), available devices for communicating within a telepresence session, settings/preferences for a user, telepresence profiles, device capabilities, device selection criteria, authentication data, archived data, telepresence session attendees, presented materials, summarization of telepresence sessions, any other suitable data related to the system 300, etc.

It is to be appreciated that the data store 306 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 306 of the subject systems and methods is intended to comprise, without being limited to, these and any other suitable types of memory. In addition, it is to be appreciated that the data store 306 can be a server, a database, a hard drive, a pen drive, an external hard drive, a portable hard drive, and the like.

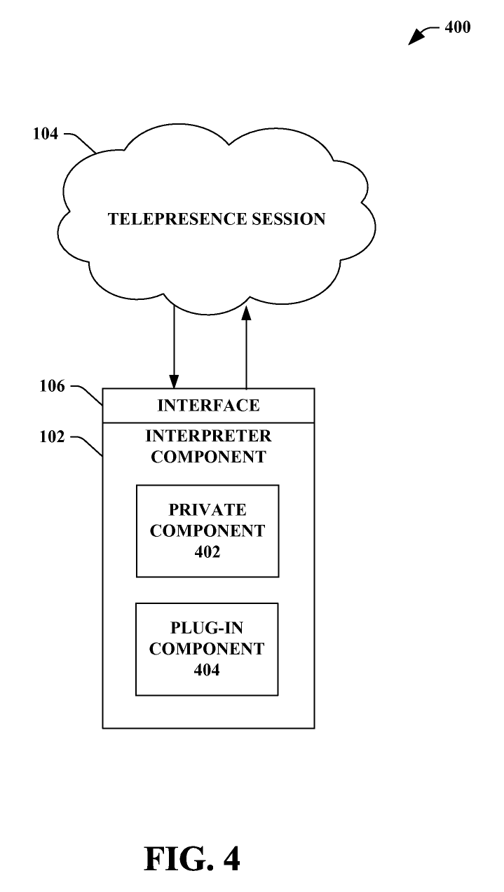

FIG. 4 illustrates a system 400 that facilitates interacting with a participant within a telepresence session while excluding other participants from such communications. The system 400 can further employ enhanced features or capabilities by leveraging a private component 402. The private component 402 can enable two virtually represented users within the telepresence session 104 to interact or communicate with discretion. In other words, the private component 402 can allow two users within the telepresence session 104 to initiate a communication that is private and not shared to other participants within the telepresence session 104. For example, a telepresence session can include a first group and a second group, wherein the first group of virtually represented users can be physically present in a first room and the second group of virtually represented users can be physically located in a second room. By employing the private component 402, a user from the first group can communicate with a user from the second group without other telepresence session participants having access or receiving such communication or interaction. Such private interaction or communication provided within the telepresence session 104 can be substantially similar to a physical whisper or note-passing between two physical users.

The system 400 can further include a plug-in component 404 that can expand the features and capabilities of the automatically initiated telepresence session 104 and/or the smart meeting room. The plug-in component 404 can allow seamless and universal incorporation of applications, hardware, software, communications, devices, and the like. In general, the plug-in component 404 can receive or transmit information related to the telepresence session 104 in which such data can be utilized with disparate applications, hardware, software, communications, devices, and the like. It is to be appreciated that the plug-in component 404 can allow for expansion in connection to any suitable feature of the telepresence session 104 and/or the automatic telepresence engine 102, wherein such expansion can relate to data collection, communications, organization of data, authentication, profiles, etc.

FIG. 5 illustrates a system 500 that facilitates enabling two or more virtually represented users to communicate within a telepresence session on a communication framework. The system 500 can include at least one physical user 502 that can leverage a device 504 on a client side in order to initiate a telepresence session 506 on a communication framework. Additionally, the user 502 can utilize the Internet, a network, a server, and the like in order to connect to the telepresence session 506 hosted by the communication framework. In general, the physical user 502 can utilize the device 504 in order to provide input for communications within the telepresence session 506 as well as receive output from communications related to the telepresence session 506. The device 504 can be any suitable device or component that can transmit or receive at least a portion of audio, a portion of video, a portion of text, a portion of a graphic, a portion of a physical motion, and the like. The device can be, but is not limited to being, a camera, a video capturing device, a microphone, a display, a motion detector, a cellular device, a mobile device, a laptop, a machine, a computer, etc. For example, the device 504 can be a web camera in which a live feed of the physical user 502 can be communicated for the telepresence session 506. It is to be appreciated that the system 500 can include a plurality of devices 504, wherein the devices can be grouped based upon functionality (e.g., input devices, output devices, audio devices, video devices, display/graphic devices, etc.).

The system 500 can enable a physical user 502 to be virtually represented within the telepresence session 506 for remote communications between two or more users or entities. The system 500 further illustrates a second physical user 508 that employs a device 510 to communicate within the telepresence session 506. As discussed, it is to be appreciated that the telepresence session 506 can enable any suitable number of physical users to communicate within the session. The telepresence session 506 can be a virtual environment on the communication framework in which the virtually represented users can communicate. For example, the telepresence session 506 can allow data to be communicated such as, voice, audio, video, camera feeds, data sharing, data files, etc. It is to be appreciated that the subject innovation can be implemented for a meeting/session in which the participants are physically located within the same location, room, or meeting place (e.g., automatic initiation, automatic creation of summary, etc.).

Overall, the telepresence session 506 can simulate a real world or physical meeting place substantially similar to a business environment. Yet, the telepresence session 506 does not require participants to be physically present at a location. In order to simulate the physical real world business meeting, a physical user (e.g., the physical user 502, the physical user 508) can be virtually represented by a virtual presence (e.g., the physical user 502 can be virtually represented by a virtual presence 512, the physical user 508 can be represented by a virtual presence 514). It is to be appreciated that the virtual presence can be, but is not limited to being, an avatar, a video feed, an audio feed, a portion of a graphic, a portion of text, etc.

For instance, a first user can be represented by an avatar, wherein the avatar can imitate the actions and gestures of the physical user within the telepresence session. The telepresence session can include as second user that is represented by a video feed, wherein the real world actions and gestures of the user are communicated to the telepresence session. Thus, the first user can interact with the live video feed and the second user can interact with the avatar, wherein the interaction can be talking, typing, file transfers, sharing computer screens, hand-gestures, application/data sharing, etc.

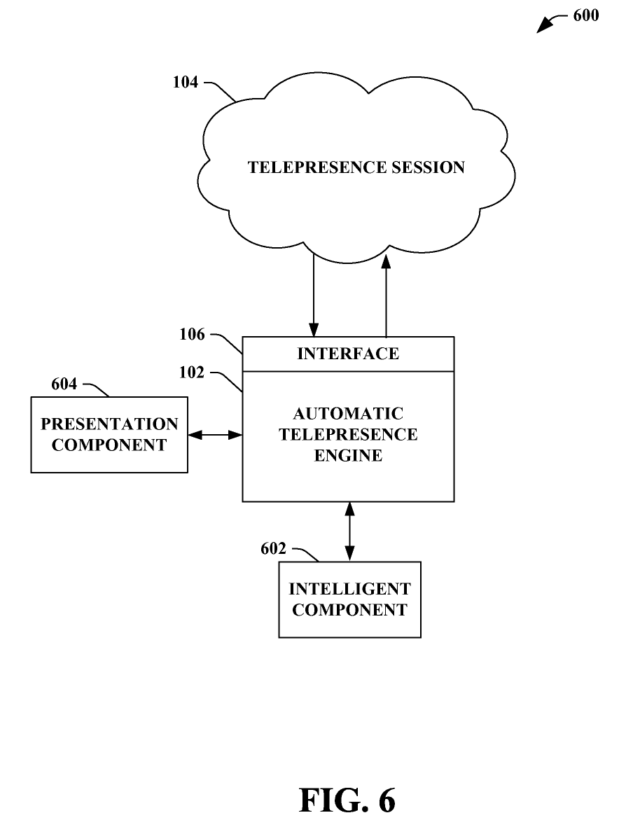

FIG. 6 illustrates a system 600 that employs intelligence to facilitate automatically conducting a telepresence session for two or more virtually represented users. The system 600 can include the automatic telepresence engine 102 and the telepresence session 104, which can be substantially similar to respective components, and sessions described in previous figures. The system 600 further includes an intelligent component 602. The intelligent component 602 can be utilized by the automatic telepresence engine 102 to facilitate automatically conducting a telepresence session based upon evaluated data.

For example, the intelligent component 602 can infer data associated with at least one of a virtually represented user (e.g., personal information, employment information, profile data, biographical information, etc.), a schedule for a virtually represented user (e.g., calendar, online calendar, physical calendar, scheduling data on a device, electronic mail application, etc.), a portion of an electronic communication for a virtually represented user (e.g., phone calls, emails, online communications, text messages, short message service (SMS) messages, chat program communications, physical mail, pages, messaging applications, voicemails, etc.), a participant to include for the telepresence session, a portion of data related to a presentation within the telepresence session, a portion of data related to a meeting topic within the telepresence session, a device utilized by a virtually represented user to communicate within the telepresence session, data to archive, tags/metadata for archived data, summarization of telepresence sessions, authentication, verification, telepresence profiles, private conversations between virtually represented users, etc.

The intelligent component 602 can employ value of information (VOI) computation in order to identify which telepresence sessions to schedule and when (e.g., a first telepresence session regarding a high priority matter can be scheduled prior to a second telepresence session having a lower priority). For instance, by utilizing VOI computation, the most ideal and/or appropriate dates and priorities for telepresence sessions can be determined. Moreover, it is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The automatic telepresence engine 102 can further utilize a presentation component 604 that provides various types of user interfaces to facilitate interaction between a user and any component coupled to the automatic telepresence engine 102. As depicted, the presentation component 604 is a separate entity that can be utilized with the automatic telepresence engine 102. However, it is to be appreciated that the presentation component 604 and/or similar view components can be incorporated into the automatic telepresence engine 102 and/or a stand-alone unit. The presentation component 604 can provide one or more graphical user interfaces (GUls), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the automatic telepresence engine 102.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

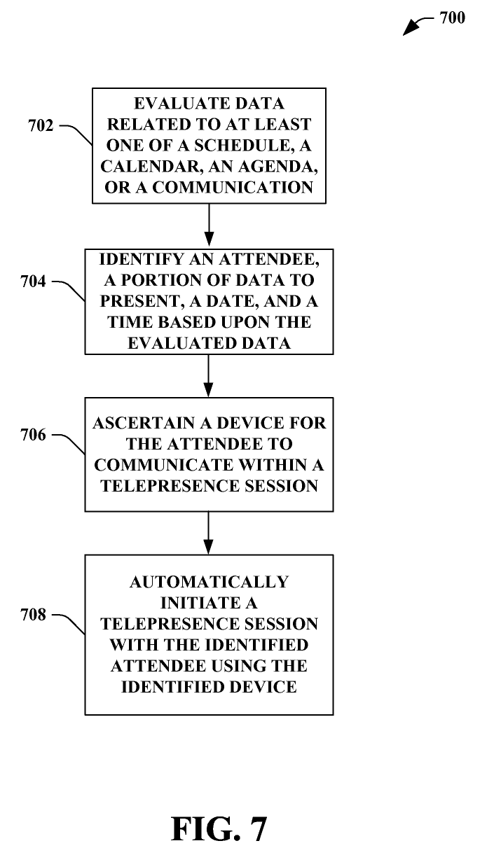

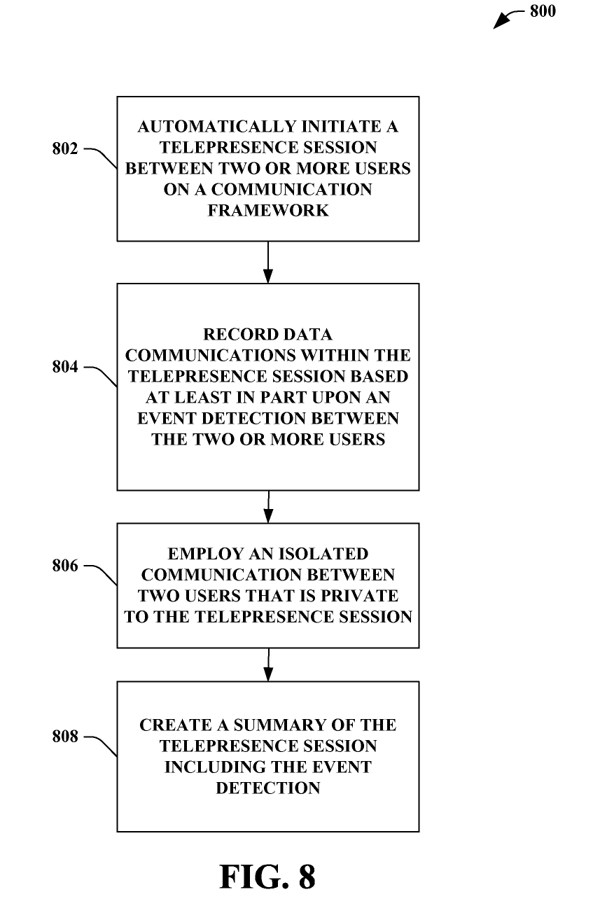

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates automatically initiating a telepresence session for participants and related data. At reference numeral 702, data related to at least one of a schedule, a calendar, an agenda, or a communication can be evaluated. For example, the evaluated data can be, but is not limited to, data associated with at least one of a virtually represented user (e.g., personal information, employment information, profile data, biographical information, etc.), a schedule for a virtually represented user (e.g., calendar, online calendar, physical calendar, scheduling data on a device, electronic mail application, etc.), or a portion of an electronic communication for a virtually represented user (e.g., phone calls, emails, online communications, text messages, short message service (SMS) messages, chat program communications, physical mail, pages, messaging applications, voicemails, etc.).

At reference numeral 704, an attendee, a portion of data to present, a date, and a time can be identified based upon the evaluated data. In other words, the evaluation of data can identify who is attending a telepresence session, what is presented at a telepresence session, and when the telepresence session is to be conducted. At reference numeral 706, a device for at least one attendee to communicate within a telepresence session can be ascertained. For example, the device can be any suitable electronic device that can receive inputs or communicate outputs corresponding to a telepresence session. At reference numeral 708, a telepresence session can be automatically initiated with the identified attendee using the identified device.

FIG. 8 illustrates a method 800 for seamlessly collecting data corresponding to a telepresence session, attendees, or presented material. At reference numeral 802, a telepresence session between two or more users can be automatically initiated on a communication framework. At reference numeral 804, data communications within the telepresence session can be recorded based upon event detection between two or more users. For example, the event detection can relate to events such as, but not limited to, topics presented, data presented, who is presenting, what is being presented, time lapse, date, movement within the telepresence session, changing between devices for interaction within the telepresence session, arrival within the session of virtually represented users, departure from the session from virtually represented users, tone of voice, number of people speaking a moment in time, etc.

At reference numeral 806, an isolated communication can be employed between two users, wherein the isolated communication is private to the telepresence session and/or disparate users outside the communication. For example, the private conversation can be substantially similar to a whisper or a note-passing in which a communication can be discretely presented. At reference numeral 808, a summary of the telepresence session can be created that includes the event detection. Moreover, such summary can be delivered to users for reference. The summary can be, for instance, a transcription, an outline, an audio file, a video file, a word processing document, a meeting minutes document, a portion of data with participant identified data (e.g., user-tagging, etc.), pictures, photos, presented material, etc.

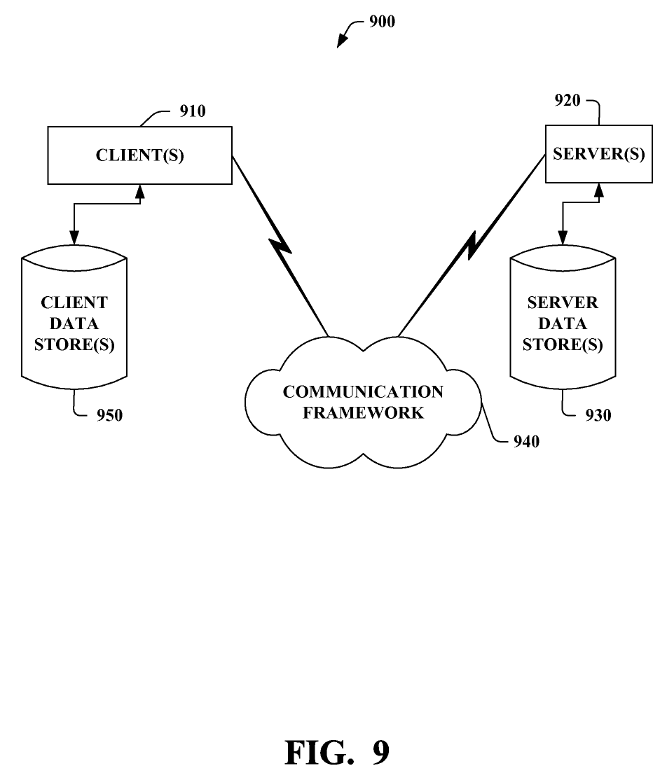

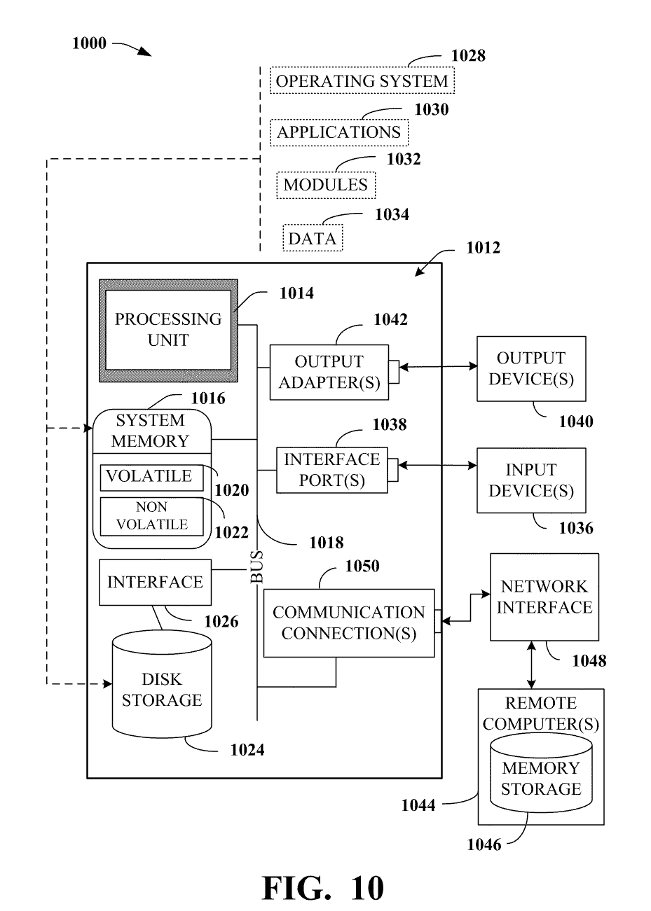

In order to provide additional context for implementing various aspects of the claimed subject matter, FIGS. 9-10 and the following discussion is intended to provide a brief, general description of a suitable computing environment in which the various aspects of the subject innovation may be implemented. For example, an automatic telepresence engine can evaluate data in order to automatically initiate a telepresence session, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 9 10. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements. What is claimed is:

1. A system that facilitates enhancing the employment of a telepresence session, comprising:
an automatic telepresence engine that evaluates data associated with at least one of an attendee, a schedule for a virtually represented user, or a portion of an electronic communication for an attendee, wherein the attendee is a physical participant or a virtually represented user;
the automatic telepresence engine identifies at least one the following for a telepresence session based upon the evaluated data: an identity of a participant to include for the telepresence session, a portion of data related to a presentation within the telepresence session, a portion of data related to a meeting topic within the telepresence session, a need for a telepresence session, or a device utilized by an attendee to communicate within the telepresence session; and
the automatic telepresence engine initiates the telepresence session within a communication framework that includes two or more virtually represented users that communicate therein.

2. The system of claim 1, the data associated with the attendee is at least one of a portion of personal information, a portion of employment information, a portion of profile data, or a portion of biographical information.

3. The system of claim 1, the schedule for the attendee is at least one of a calendar, an online calendar, a physical calendar, a portion of scheduling data on a device, or a portion of data related to electronic mail application.

4. The system of claim 1, the portion of the electronic communication for an attendee is at least one of a phone call, a voice call, an email, an online communication, a text message, a short message service (SMS) message, a chat program communication, a portion of physical mail, a numeric page, a alphanumeric page, a messaging application, or a voicemail.

5. The system of claim 1, further comprising a data collector that ascertains whether or not the telepresence session is to be initiated between two or more attendees in order to virtually discuss at least one of a topic, a portion of data, or a document.

6. The system of claim 5, the data collector determines to initiate the telepresence session based upon the evaluation of at least one of a communication between two users, an interaction between two users, an assignment, a project, a portion of a workload, a portion of scheduling data, a portion of calendar data, a deadline, a location of an attendee, or a timeline for an action item.

7. The system of claim 1, further comprising a communication module that manages at least one available device for an attendee in which the management includes selecting at least one device for a portion of interaction within the telepresence session based at least in part upon at least one of an input capability of the device or an output capability of the device.

8. The system of claim 7, the communication module ascertains an optimal mode of delivery for a portion of data within the telepresence session based upon at least one of a network bandwidth, a device feature, a device screen size, a device availability, a device performance, a device memory capacity, a device processor speed, a device peripheral, a device resolution, a device Internet access, a device security, a device input capability, a device output capability, a geographic location of a user, a geographic location of a device, a device service plan, a user-preference, a size of data to deliver, a sensitivity of data to deliver, or a timeliness of delivery.

9. The system of claim 7, further comprising at least one of the following:
the communication module seamlessly bridges a local user on a first network and a remote user on a second network; or
the communication module adjusts at least one of the input capability or the output capability.

10. The system of claim 1, further comprising an organizer that records a portion of data related to the telepresence session, the portion of data is at least one of a communication within the telepresence session, a portion of an audio communication, a portion of a video communication, a portion of a graphic communication, a portion of data presented within the telepresence session, a portion of data accessed within the telepresence session, a portion of data reviewed within the telepresence session, a transcription of a communication within the telepresence session, a portion of text from the telepresence session, a list of attendees within the telepresence session, a portion of notes taken by individual participants during the telepresence session, a portion of a communication within a related and disparate telepresence session that occurs after the telepresence session, the portion of data updates a participant based upon a temporary leave from the telepresence session, or a participation of attendees.

11. The system of claim 10, the organizer archives the recorded portion of data with at least one of a portion of metadata describing the recorded data based upon an event, the event is at least one of a topics presented, a portion of data presented, an attendee who is presenting, a portion of data that is being presented, a time lapse, a date, a movement within the telepresence session, a changing between devices for interaction within the telepresence session, an arrival within the telepresence session, a tone of voice, a number of participants speaking at a moment in time, or a departure from the telepresence session.

12. The system of claim 10, the organizer creates a summarization of the recorded portion of data and transmit the summarization to at least one user, the summarization of the recorded portion of data is at least one of a transcription, an outline, an audio file, a video file, a word processing document, a compilation of meeting minutes, a portion of data with participant identified data, a picture, a photo, or a portion of presented data.

13. The system of claim 10, the organizer enables at least one of the following:
a sharing of the recorded portion of data with at least one of a user, an entity, a group, an enterprise, a web site, the Internet, a server, a network, a telepresence session, a machine, a device, a computer, an attendee within a telepresence session, or a portable device; or
a linking of the recorded portion of data based upon a relationship with at least one of a user, an entity, a group, an enterprise, a web site, the Internet, a server, a network, a telepresence session, a machine, a device, a computer, an attendee within a telepresence session, or a portable device.

14. The system of claim 1, further comprising an authentication component verifies at least one of a virtually represented participant, a portion of data access, a network access, a server access, a connectivity associated with the telepresence session, or a portion of a data file.

15. The system of claim 1, further comprising a profile manager that manages a telepresence profile for the attendee participating within the telepresence session, the telepresence profile includes at least one of a portion of biographical information, a geographic location, a device used for telepresence, a portion of authentication information, a security detail, a privacy setting, an archiving preference, or a portion of information related to initiating/conducting telepresence sessions based on a preference.

16. The system of claim 1, further comprising a private component that enables two attendees within the telepresence session to communicate with one another in a discrete manner that is isolated from disparate attendees within the telepresence session.

17. A computer-implemented method that facilitates conducting a telepresence session, comprising:
evaluating data related to at least one of a schedule, a calendar, an agenda, or a communication;
identifying at least one of an attendee, a portion of data to present, a date, and a time based upon the evaluated data;
ascertaining a device for the attendee to communicate within a telepresence session; and
automatically initiating a telepresence session with the identified attendee using the identified device.

18. The method of claim 17, further comprising:
recording a portion of a data communication within the telepresence session based at least in part upon an event detection between two or more users; and
creating a summary of the telepresence session including the event detection.

19. The method of claim 17, further comprising employing an isolated communication between two users within the telepresence session that is private to disparate users within the telepresence session.

20. A computer-implemented system that facilitates enhancing the employment of a telepresence session, comprising:
means for evaluating data associated with the identity of at least one of an attendee, a schedule for an attendee, or a portion of an electronic communication for an attendee;
means for identifying at least one the following for a telepresence session based upon the evaluated data: a participant to include for the telepresence session, a portion of data related to a presentation within the telepresence session, a portion of data related to a meeting topic within the telepresence session, a device utilized by an attendee to communicate within the telepresence session;
means for initiating the telepresence session within a communication framework that includes two or more attendees that communicate therein;
means for recording a portion of data related to the telepresence session;
means for archiving the portion of data with at least one of a portion of metadata describing the recorded data based upon an event; and
means for employing an isolated communication between two users within the telepresence session that is private to disparate users within the telepresence session.
